(19) United States
(12) Patent Application Publication
(10) Pub. No.: US 2026/0094546 A1
(43) Pub. Date: Apr. 2, 2026

(54) Mounting System for Attaching Signs to Sign Support Pos

(71) Applicant: Loren Brian Nelson, Ralls, TX (US)

(72) Inventor: Loren Brian Nelson, Ralls, TX (US)

(21) Appl. No.: 19/346,367

(22) Filed: Sep. 30, 2025

Related U.S. Application Data
(60) Provisional application No. 63/701,533, filed on Sep. 30, 2024.

(51) Int. Cl. G09F 7/18

(52) U.S. Cl. CPC G09F 7/18; G09F 2007/1817; G09F 2007/1878

(57) ABSTRACT

A mounting system for attaching a sign to a sign support post comprises a first clamp plate member and a second clamp plate member, each shaped to conform to an exterior of the tubular support post and configured to securely engage the tubular support post, a first plurality of lugs projecting from the surface of the first clamp plate member, a second plurality of lugs projecting from the surface of the second clamp plate member, a plurality of fasteners each configured to pass through a first lug and a second lug to securely fasten the first clamp plate member to the second clamp plate member around the support post, a first tube member fixed to the first clamp plate member, and a second tube member fixed to the second clamp plate member, wherein the first tube member and the second tube member are configured for attachment of the roadway sign.

### CROSS-REFERENCE TO RELATED APPLICATIONS

This application claims priority to U.S. Provisional Application No. 63/701,533, filed on Sep. 30, 2024, the disclosure of which is incorporated herein by reference. All publications, patents, patent applications, databases and other references cited in this application, all related applications referenced herein, and all references cited therein, are incorporated by reference in their entirety as if restated here in full and as if each individual publication, patent, patent application, database or other reference were specifically and individually indicated to be incorporated by reference.

### BACKGROUND OF THE INVENTION

### 1. Field of the Invention

The present invention generally relates to a mounting system for attaching signs to sign support posts, and more specifically to mounting systems for attaching signs to sign support posts located adjacent to roadways.

### 2. Description of Related Art

Traffic signs communicate rules, warnings, guidance, and other highway agency information that drivers need to safely and efficiently navigate roads and streets. Sign support posts are vertical posts used to display traffic signs. Many support posts for roadside signs are configured as round tube steel posts. These posts are often anchored with breakaway bases in order to comply with regulatory safety standards.

Due to the location of signs and sign support posts on the roadside, sign support posts can become a deadly hazard when struck by a vehicle. If not properly designed, these posts can cause severe vehicle damage, occupant injury, or even fatalities. Therefore, the Federal Highways Administration (“FHWA”) requires roadside sign support posts to be breakaway, yielding, or shielded by a barrier or crash cushion. Breakaway support posts are designed to break or bend upon impact to reduce the severity of vehicle crashes. This includes sign support posts that, when struck by a vehicle, separate from the base and are knocked ahead of, or up and over, the vehicle.

A yielding support is configure to bend and allow a vehicle to run over it.

Design problems with current sign support systems present many disadvantages that are overcome by the present invention. Existing mounting systems commonly rely on pre-drilled holes through the round tube steel sign support posts, typically located near the top of the support post. This configuration requires signs to be mounted only at specific heights, limiting flexibility for different sign sizes or multiple sign assemblies on a single post. In addition, drilling holes through the support post can weaken the structural integrity of the post, potentially affecting its breakaway performance and increasing the likelihood of post deformation or premature failure under wind load or impact.

Furthermore, conventional one-piece mounting brackets require the installer to lift the bracket over the top of the post, necessitating additional equipment or personnel for installation at higher elevations. This results in increased labor costs, safety hazards during installation, and longer setup times. Current one-piece mounting systems are difficult to transport, carry, and install.

Additionally, the Manual for Assessing Safety Hardware (“MASH”), developed by the American Association of State Highway and Transportation Officials (“AASHTO”), sets updated crash testing and performance criteria for roadside safety devices in the U.S. To be considered MASH-compliant, sign support posts, particularly small sign supports like single-post ground-mounted signs, must use breakaway systems that have been tested and passed MASH impact criteria. MASH has strict occupant risk criteria and requires support post devices to behave predictably during crashes. Specifically, the support post must break, yield, or safely detach without penetrating the occupant compartment or causing vehicle instability. The MASH criteria focus more on occupant safety, not just structural performance, and require redesigning mounting systems for attaching signs to sign support posts to detach in a way that minimizes impact severity.

The FHWA requires all new installations of roadside safety devices on the National Highway System use MASH-compliant hardware for most devices, including sign supports. To make roadway signs MASH-compliant, agencies and manufacturers must ensure that support posts, mounting hardware, and foundations meet updated breakaway performance, occupant risk limits, and structural criteria under the MASH crash testing protocol. This often involves redesign, material substitution, and retesting of existing sign systems.

In accordance with the MASH performance criteria, roadside sign supports must exhibit predictable and controlled behavior upon vehicular impact to reduce occupant risk and vehicle damage. The disclosed system facilitates MASH compliance by enabling the secure attachment of traffic signs to round tube steel support posts without the need for through-bolts or permanent modifications that could adversely affect breakaway performance. By preserving the structural integrity of the support post and allowing the post to behave as intended under impact, the disclosed system supports proper breakaway or yielding action consistent with MASH requirements. Further, the disclosed system is compatible with MASH-approved breakaway bases and can be positioned at any height along a support post without introducing stress concentrations or weakening the post wall. Additionally, the two-piece clamp design simplifies proper installation. By reducing the need for field drilling and providing a consistent, repeatable attachment method, the disclosed mounting system improves the likelihood that installed sign assemblies will conform to MASH standards throughout their service life.

Applicant has been involved with the design, development, installation, and manufacture of roadway sign support posts for approximately thirty years, and has contributed to the art of breakaway sign support assemblies, including developing a widely used triangular slip base mounting system for roadway sign support posts that uses a clamping system with exterior bolts to hold the sign support post in place within a tapered bore. The disclosed invention provides a clamp attachment mechanism comprising two separate components and a plurality of fasteners to attach a U-shaped or a T-shaped sign mounting device to a round tube steel sign support post.

The disclosed U-shaped or T-shaped mounting system for a sign support post provides a secure attachment means for signs mounted anywhere along the vertical body of a round tube steel support post. The clamp system of the disclosed mounting system provides a stronger attachment mechanism compared to existing prior art sleeve-type mounting brackets requiring a bolt through the support post. Because the disclosed system comprises two separate components, it is lighter, more compact, and easier to transport, carry, and install than existing one-piece mounting brackets.

Due to the two-piece design of the disclosed mounting system, the T-shaped or U-shaped mounting device can be attached to the post anywhere and at any height on the sign support post.

This eliminates the requirement of attaching current mounting systems to round tube steel sign support posts by placing the mounting system at the top of the support post where a hole has been drilled through the support post. As a result, the disclosed system eliminates the need for drilling, field modification, or lifting the bracket over the top of the post. The components of the disclosed system can be easily positioned around the post and secured using standard hand tools, reducing installation time and minimizing worker exposure to roadside traffic during installation and maintenance operations.

The disclosed mounting system improves the versatility and adaptability of roadside sign installations. The modular nature of the clamp system facilitates rapid removal, replacement, or repositioning of signs in the field without the need to remove the entire post or disturb the foundation.

In view of the foregoing, it is apparent that a need exists in the art for a mounting system for attaching signs to support posts that overcomes, mitigates or solves the above problems in the art. It is a purpose of this invention to fulfill this and other needs in the art which will become more apparent to the skilled artisan once given the following disclosure.

### OBJECTS AND SUMMARY OF THE INVENTION

It is an object of the present invention to overcome the above-described drawbacks associated with current mounting systems for attaching signs to support posts. To achieve these and other advantages and in accordance with the purpose of the invention, as embodied and broadly described, the present disclosure describes a mounting system for attaching U-shaped and T-shaped mounting brackets to sign support posts.

The disclosed invention provides a two-piece clamp system comprising a plurality of fasteners (e.g., nuts and bolts) to securely attach a U-shaped or a T-shaped sign mounting device to a round tube steel sign support post. The disclosed U-shaped or T-shaped mounting device for a support post provides a secure attachment means for signs mounted anywhere along the vertical body of a round tube steel sign support post. The clamp system of the disclosed mounting device establishes a rigid, non-slip connection with the support post, ensuring that the mounting device remains securely fixed under operational and environmental loads. This clamp system provides a secure attachment to the support post that resists movement, rotation, and loosening over time.

The disclosed system is designed to provide a versatile, durable, and efficient means of securing traffic signs to round tube steel support posts without the need for through-bolts, pre-drilled holes, or top-loading of the mounting device. The two-piece construction of the mounting system provides significant advantages over conventional one-piece brackets. Each component can be individually handled, positioned, and fastened, simplifying installation and minimizing the need for specialized tools or additional personnel. This modular design makes the device easier to transport, carry, and install, particularly in roadside environments where efficiency and worker safety are critical.

These, together with other objects of the invention, along with various features of novelty that characterize the invention, are pointed out with particularity in the claims annexed hereto and forming a part of this disclosure. For a better understanding of the invention, its operating advantages, and the specific objects attained by its uses, reference should be had to the accompanying drawings and descriptive matter in which there is described illustrative embodiments of the invention.

### BRIEF DESCRIPTION OF THE DRAWINGS

The accompanying drawings, which are incorporated in and form a part of the specification, illustrate embodiments of the present invention, and together with the description, serve to explain the principles of the invention. It is to be expressly understood that the drawings are for the purpose of illustration and description only and are not intended as a definition of the limits of the invention. In the drawings:

FIG. 1 is a perspective view of a mounting system for attaching signs to sign support posts constructed in accordance with the teachings of the present disclosure.

FIG. 2 is a side view of the mounting system shown in FIG. 1.

FIG. 3 is a side view of a portion of the mounting system shown in FIG. 1.

FIG. 4 is a top view of a portion of the mounting system shown in FIG. 1.

FIG. 5 is a front view of a portion of the mounting system shown in FIG. 1.

FIG. 6 is an exploded perspective view of a portion of the mounting system shown in FIG. 1.

FIG. 7 is a perspective view of a mounting system for attaching signs to sign support posts constructed in accordance with the teachings of the present disclosure.

FIG. 8 is a side view of the mounting system shown in FIG. 7.

### DETAILED DESCRIPTION OF ILLUSTRATIVE EMBODIMENTS

Exemplary embodiments of a mounting system for attaching signs to sign support posts in accordance with the present disclosure are discussed below. Many other uses of the present invention will become obvious to one skilled in the art upon acquiring a thorough understanding of the present invention. Once given the below disclosures, many other features, modifications and variations will become apparent to the skilled artisan in view of the teachings set forth herein. Such other features, modifications and variations are, therefore, considered to be a part of this invention.

The disclosed mounting system 10 for attaching a sign to a sign support post comprises a first clamp plate member 15 shaped to conform to an exterior of a tubular support post 11 and configured to securely engage said tubular support post 11; a second clamp plate member 16 shaped to conform to an exterior of a tubular support post 11 and configured to securely engage a tubular support post 11; a first plurality of lugs 22 projecting from the surface of the first clamp plate member 15, the first plurality of lugs 22 configured to receive fasteners 17 for securing the first clamp plate member 15 to the second clamp plate member 16, thereby securing said mounting system 10 to said tubular support post 11; a second plurality of lugs 23 projecting from the surface of the second clamp plate member 16, the second plurality of lugs 23 configured to receive said fasteners 17 for securing the second clamp plate member 16 to the first clamp plate member 15, thereby securing said mounting system 10 to said tubular support post 11; a plurality of fasteners 17 configured to securely fasten said first clamp plate member 15 to said second clamp plate member 16 around said support post 11; a first tube member 12 fixed to said first clamp plate member 15, wherein said first tube 12 is arranged and configured for attachment of a roadway sign; a second tube member 13 fixed to said second clamp plate member 16, wherein said second tube member 13 is arranged and configured for attachment of said roadway sign.

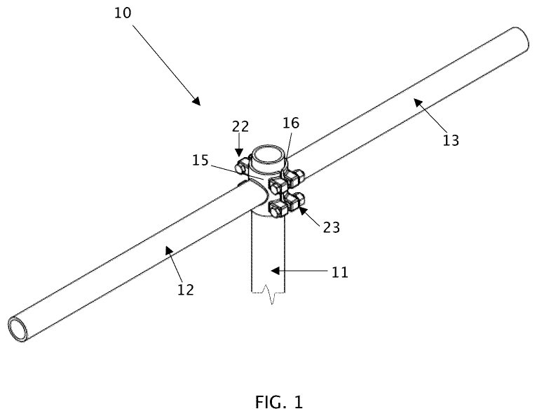

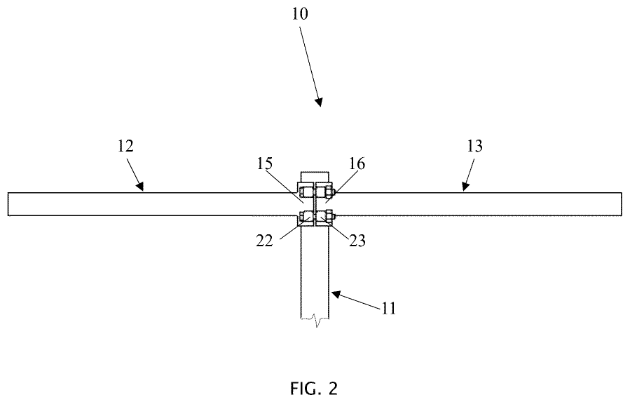

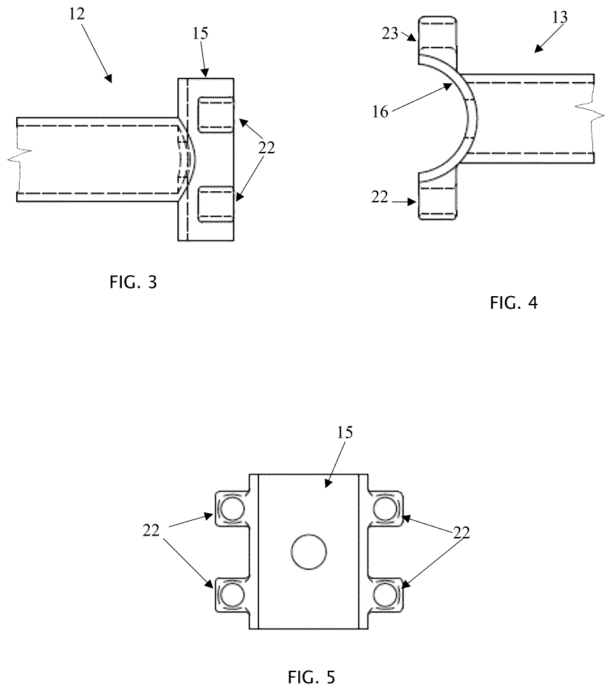

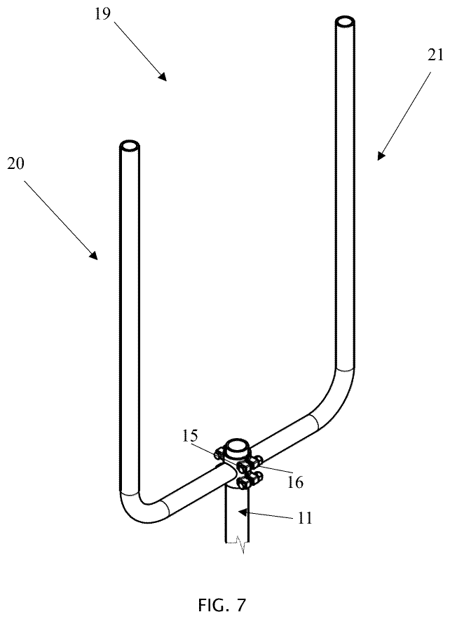

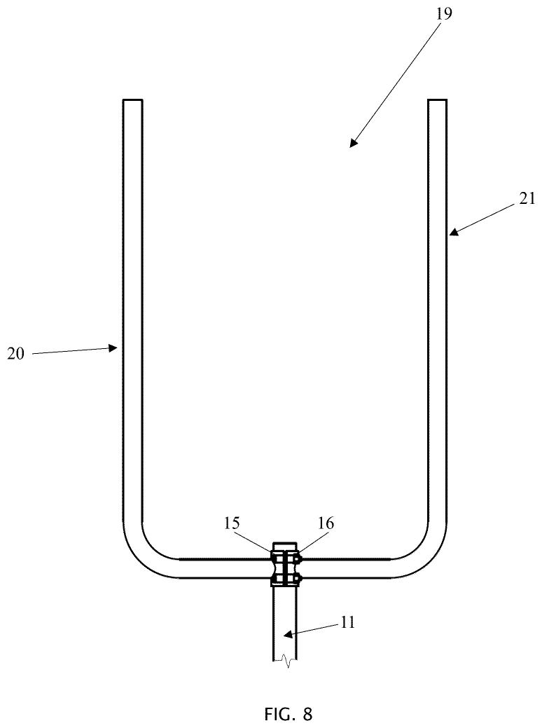

Turning to FIGS. 1-2 and 7-8, the first tube member and the second tube member are arranged and configured for fixed attachment of one or more roadway signs to said first and second tube members. As depicted in FIGS. 1 and 2, the first tube member 12 and the second tube member 13 may be configured to form a T-shape with the sign support post 11. Alternatively, as depicted in FIGS. 7 and 8, the first tube member 20 and the second tube member 21 may be bent and configured to form a U-shape. It should be understood that the first tube member and the second tube member may be configured to form any suitable shape for mounting one or more roadway signs to the first and second tube members.

In one embodiment anticipated by the present disclosure, the first tube member and the second tube member are made from a small diameter tubing (e.g., tubing having a diameter of 2⅜ inches). Other sizes of tubing may be used to accomplish the objectives discussed herein.

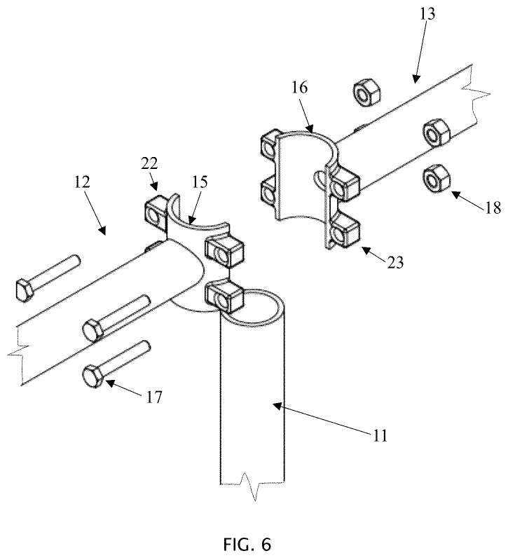

The plurality of lugs 22 projecting from the first clamp plate 15 and the plurality of lugs 23 projecting from the second clamp plate 16 allow the first and second clamp plates to be securely fastened together and to be securely fastened to the support post. The first clamp plate with its projecting lugs mirrors the second clamp plate with its projecting lugs, as shown in FIG. 6. As a result, each of the projecting lugs on the first clamp plate corresponds to a projecting lug on the second clamp plate (see FIG. 1). A fastener is passed through a projecting lug on the first clamp plate and through a corresponding projecting lug on the second clamp plate. If bolts 17 and nuts 18 are used as the fasteners, a bolt 17 is passed through a projecting lug 22 on the first clamp plate and the bolt 17 is passed through a corresponding projecting lug 23 on the second clamp plate and a nut 18 is fastened to the end of the bolt after it passes through the lug on the second clamp plate (see FIGS. 1-2 and 7-8).

Each of the plurality of fasteners 17 is passed through one lug 22 projecting from the first clamp plate and through one opposing lug 23 projecting from the second clamp plate. This arrangement and configuration allow the first clamp plate member 15 to securely fasten to the second clamp plate member 16, thereby securely fastening the disclosed system around the sign support post 11 as depicted in FIGS. 1-2 and 7-8. The first and second clamp plates are shaped to conform to the exterior of the support post in order to securely engage the support post, as depicted in FIGS. 1-2 and 7-8.

In one preferred embodiment, the disclosed system, including the first and second clamp plates, is made of steel. It should be understood, however, that the clamp plates and other elements of the disclosed system alternatively may be constructed from any suitable material known to those skilled in the art without departing from the spirit and scope of the invention.

It is important to note that the construction and arrangement of the elements of the invention provided herein are illustrative only. Although only a few exemplary embodiments of the present invention have been described in detail in this disclosure, those skilled in the art who review this disclosure will readily appreciate that many modifications are possible in these embodiments (such as variations in orientation of the components of the system, sizes, structures, shapes and proportions of the various components, etc.) without materially departing from the novel teachings and advantages of the invention.

Many other uses of the present invention will become obvious to one skilled in the art upon acquiring a thorough understanding of the present invention. Once given the above disclosures, many other features, modifications and variations will become apparent to the skilled artisan in view of the teachings set forth herein. Such other features, modifications and variations are, therefore, considered to be a part of this invention.

The invention claimed is:

1. A mounting system for attaching roadway signs to sign support posts, comprising:
a first clamp plate member shaped to conform to an exterior of a tubular support post and configured to securely engage said tubular support post;
a second clamp plate member shaped to conform to an exterior of a tubular support post and configured to securely engage a tubular support post;
a first plurality of lugs projecting from the surface of the first clamp plate member, the first plurality of lugs configured to receive fasteners for securing the first clamp plate member to the second clamp plate member, thereby securing said mounting system to said tubular support post;
a second plurality of lugs projecting from the surface of the second clamp plate member, the second plurality of lugs configured to receive fasteners for securing the second clamp plate member to the first clamp plate member, thereby securing said mounting system to said tubular support post;
a first tube member fixed to said first clamp plate member, wherein said first tube is arranged and configured for attachment of a roadway sign; and
a second tube member fixed to said second clamp plate member, wherein said second tube member is arranged and configured for attachment of said roadway sign.

2. The mounting system of claim 1, wherein the first tube member and the second tube member are configured to form a T-shape with the sign support post.

3. The mounting system of claim 1, wherein the first tube member and the second tube member are configured to form a U-shape.

4. The mounting system of claim 1, wherein said plurality of lugs projecting from the first clamp plate and said plurality of lugs projecting from the second clamp plate are arranged and configured to allow the first clamp plate and the second clamp plate to be securely fastened together and to be securely fastened to the support post.

5. The mounting system of claim 1, wherein the first clamp plate with its plurality of projecting lugs mirrors the second clamp plate with its plurality of projecting lugs.

6. The mounting system of claim 5, wherein one of said plurality of fasteners is passed through a projecting lug on the first clamp plate and through a corresponding projecting lug on the second clamp plate.

7. The mounting system of claim 1, wherein said plurality of fasteners are defined as bolts and nuts.

8. The mounting system of claim 7, wherein each one of said bolts is passed through a projecting lug on the first clamp plate and the bolt is passed through a corresponding projecting lug on the second clamp plate and one of said nuts is fastened to the end of said bolt after it passes through the lug on the second clamp plate.

9. A mounting system for attaching roadway signs to tubular support posts, comprising:
a first clamp plate member shaped to conform to an exterior of a tubular support post and configured to securely engage said tubular support post;
a second clamp plate member shaped to conform to the exterior of said tubular support post and configured to securely engage said tubular support post;
a first plurality of lugs projecting from the surface of the first clamp plate member, the first plurality of lugs configured to receive fasteners for securing the first clamp plate member to the second clamp plate member;
a second plurality of lugs projecting from the surface of the second clamp plate member, the second plurality of lugs configured to receive fasteners for securing the second clamp plate member to the first clamp plate member;
a plurality of fasteners, wherein each fastener fastens one of said first lugs to one of said second lugs, thereby fastening said first clamp plate member to said second clamp plate member around said support post;
a first tube member fixed to said first clamp plate member, wherein said first tube is arranged and configured for attachment of a roadway sign; and
a second tube member fixed to said second clamp plate member, wherein said second tube member is arranged and configured for attachment of a roadway sign.

10. The mounting system of claim 9, wherein the first tube member and the second tube member are configured to form a T-shape with the sign support post.

11. The mounting system of claim 9, wherein the first tube member and the second tube member are each bent in order to form a U-shape.

12. The mounting system of claim 9, wherein said plurality of lugs projecting from the first clamp plate and said plurality of lugs projecting from the second clamp plate are arranged and configured to allow the first clamp plate and the second clamp plate to be securely fastened together and to be securely fastened to the support post.

13. The mounting system of claim 9, wherein the first clamp plate with its plurality of projecting lugs mirrors the second clamp plate with its plurality of projecting lugs.

14. The mounting system of claim 13, wherein one of said plurality of fasteners is passed through a projecting lug on the first clamp plate and through a corresponding projecting lug on the second clamp plate.

15. A mounting system for attaching roadway signs to sign support posts, comprising:
a first clamp plate member configured to fixedly engage a tubular sign support post;
a second clamp plate member configured to fixedly engage said tubular support post;
a first lug projecting from the surface of the first clamp plate member, the lug configured to receive a fastener for securing the first clamp plate member to the second clamp plate member;
a second lug projecting from the surface of the second clamp plate member, the second lug configured to receive said fastener for securing the second clamp plate member to the first clamp plate member;
said fastener fastening said first lug to said second lug, thereby fastening said first clamp plate member to said second clamp plate member around said support post;
a first tube member fixed to said first clamp plate member, wherein said first tube is arranged and configured for attachment of a roadway sign; and
a second tube member fixed to said second clamp plate member, wherein said second tube member is arranged and configured for attachment of a roadway sign.

16. The mounting system of claim 15, wherein the first tube member and the second tube member are configured to form a T-shape with the sign support post.

17. The mounting system of claim 15, wherein the first tube member and the second tube member are each bent in order to form a U-shape.

18. The mounting system of claim 15, wherein said first lug projecting from the first clamp plate and said second lug projecting from the second clamp plate are arranged and configured to allow the first clamp plate and the second clamp plate to be securely fastened together and to be securely fastened to the support post.

19. The mounting system of claim 15, wherein the first clamp plate with said first lug mirrors the second clamp plate with said second lug.

20. The mounting system of claim 19, wherein said fastener is passed through said first lug on the first clamp plate and through the second lug on the second clamp plate, thereby securely fastening said first clamp plate to said second clamp plate in order to firmly fasten said system to said support post.
